(19) United States
(12) Patent Application Publication
(10) Pub. No.: US 2022/0329581 A1
(43) Pub. Date: Oct. 13, 2022

(54) AUTHENTICATION OF AN UNTRUSTED USER DEVICE

(71) Applicant: Capital One Services, LLC, McLean, VA (US)

(72) Inventors: Zainab Zaki, Reston, VA (US); Divya Gupta, McLean, VA (US); Brian Choe, McLean, VA (US)

(21) Appl. No.: 17/228,585

(22) Filed: Apr. 12, 2021

(51) Int. Cl. H04L 29/06; G06F 9/451

(52) U.S. Cl. CPC H04L 63/083; G06F 9/451

(57) ABSTRACT

Systems and methods for selectively authenticating an untrusted device based on a trust level are disclosed. The system can include transmitting an authentication request from a first device seeking to authenticate a second device to access to an account. The first device receives an authentication token that can be used by the second device for authentication. The authentication token can be transmitted wirelessly to the second device or can be scanned by the second device in the case that the token is a scannable image displayed on the first device. The systems can determine a trust level for the second device based on an association between the first device and the second device. The system can provide the second device a degree of access to the account that relates to the trust level.

### FIELD

The present disclosure relates generally to systems and methods for authenticating an untrusted device to have access to a secure account and, more particularly, to systems and methods for selectively authenticating a device based on a trust level calculated by an association between the untrusted device and a trusted device.

### BACKGROUND

It is common for a primary account holder to authorize more than one user device to access an account. The primary user can do so to authorize multiple devices owned by the primary user, or to authorize user devices for secondary users to access the account. Ordinarily, the process of authorizing a previously untrusted device to access an account is a cumbersome, multistep process. The primary user accesses the webpage or application associated with the account, enters personal identification information (e.g., username and password), selects to register the device as a trusted device, and proceeds to the account page. Not only is this multistep process flow a hassle for the primary user, it also contains several insecurities. What is needed, therefore, are improved systems and methods that remove the friction involved in the ordinary device authentication and registration process, while also providing a secure method of authenticating the secondary device and partitioning the degree of access provided to the second, newly authorized device.

### BRIEF SUMMARY

Examples of the present disclosure relate to digital methods for selectively authenticating a device based on a trust level calculated by an association between an untrusted device and a trusted device. The present disclosure provides a system for authenticating an untrusted device. The system can include processor and a memory to perform the process of authenticating the untrusted device. The process can include receiving an authentication request from a primary user device requesting authentication of a secondary user device such that the secondary user device can access an account. The process can include transmitting an authentication token to the primary user device. The authentication token can include data associated with the account. The process can include receiving data indicative of an authentication input from the secondary user device. The data indicative of the authentication input can indicate that the secondary user device received the authentication token. The process can include determining a trust level for the secondary user device. The process can include authenticating the secondary user device responsive to receiving the data indicative of the authentication input. The authentication can provide the secondary user device access to the account. Further, a degree of access to the account can be based upon the trust level.

Example degrees of access that can correspond to different trust levels are described herein. The authentication request can include data indicative of the secondary user device being associated with a user of the primary user device. In this case, the process can include increasing the degree of access and increasing the trust level of the secondary user device. The authentication request can include data indicative of the secondary user device being associated with a first user other than a second user of the primary user device. In this case, the process can include decreasing the degree of access and decreasing the trust level of the secondary user device. Authentication of the secondary user device can be for a limited duration of time and based on the trust level.

The authentication token can be an image displayable on the primary user device and scannable by the secondary user device. The image can include information related to the account. The image can be a Quick Response (“QR”) code that includes an encrypted account identifier for the account. Authentication of the secondary user device can be responsive to decrypting the encrypted account identifier.

The authentication request can include data indicative of a wireless connection between the primary user device and the secondary user device. The authentication token can be a file wirelessly transferrable from the primary user device to the secondary user device via the wireless connection. The data indicative of the wireless connection can include an indication of a request originating device. When the primary user device is the request originating device, the process can include assigning a first trust level to the secondary user device. When the secondary user device is the request originating device, the process can include assigning a second trust level to the secondary user device. The first trust level can be a higher trust level than the second trust level.

The process can further include generating a graphical user interface (GUI) associated with the account with a login field for login information. The process can include generating the login information for the secondary user device. The process can include automatically populating the login information into the login field, thereby allowing subsequent logins to the account using the secondary user device.

The present disclosure provides a system for authenticating a user device for accessing an account. The system can include processor and a memory to perform the process of authenticating the user device for accessing the account. The process can include receiving an indication of a short-range wireless connection between a first device and a second device. The first device can be a trusted device authenticated for viewing account information for a user account, and the second device can be an untrusted device not initially authenticated to view the account information. The process can include receiving, from either the first device or the second device, an authentication request to authenticate the second device. The process can include transmitting an authentication token to the first device configured to authenticate the second device. The process can include receiving an indication of an authentication input from the second device indicating the second device received the authentication token from the first device via the short-range wireless connection. The process can include determining a second device trust level. The process can include authenticating the second device responsive to receiving the indication of the authentication input. A degree of access to the account is based upon the second device trust level. Additional details and examples for the process for authenticating the user device for accessing the account are described herein.

The present disclosure provides a primary user device for authenticating a secondary user device. The device can include a transceiver, one or more processors, and a memory to perform the process of authenticating the secondary user device. The process can include receiving, via the transceiver, a short-range wireless connection attempt from the secondary user device. The process can include accepting the short-range wireless connection attempt. The process can include transmitting an authentication request to an authentication system seeking to authenticate the secondary user device to access an account associated with the primary user account. The process can include receiving, in response to transmitting the authentication request, an authentication token for authenticating the secondary user device. The authentication token can include data associated with the account and data related to a trust level for authenticating the secondary user device. The process can include transmitting, via the transceiver, the authentication token to the secondary user device to authenticate the secondary user device to access the account.

These and other aspects of the present disclosure are described in the Detailed Description below and the accompanying figures. Other aspects and features of examples of the present disclosure will become apparent to those of ordinary skill in the art upon reviewing the following description of specific, exemplary examples of the present invention in concert with the figures. While features of the present disclosure can be discussed relative to certain examples and figures, all examples of the present disclosure can include one or more of the features discussed herein. Further, while one or more examples can be discussed as having certain advantageous features, one or more of such features can also be used with the various examples of the invention discussed herein. In similar fashion, while exemplary examples can be discussed below as device, system, or method examples, it is to be understood that such exemplary examples can be implemented in various devices, systems, and methods of the present invention.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner In the drawings:

FIG. 1 is a diagram of an example system that can be used to implement one or more examples of the present disclosure;

FIG. 2 is a component diagram of an example user device, according to the present disclosure;

FIG. 3 is a flowchart of an example process for authenticating an untrusted device, according to the present disclosure;

FIGS. 4A-4D depict factors that can be used in determining a trust level, according to the present disclosure;

FIG. 5 is an example algorithm for determining a trust level and allocating a degree of access to an account based on the trust level, according to the present disclosure;

FIGS. 6A and 6B depict example interfaces for transmitting authentication tokens capable of authenticating a second device, according to the present disclosure;

FIG. 7 is an example graphical user interface (GUI) for a second device allowing the second device to maintain access to the account after the initial authentication, according to the present disclosure;

FIG. 8 is a flowchart of an example process for authenticating a user device for accessing an account, according to the present disclosure; and

FIG. 9 is a flowchart of an example process for a primary user device, allowing the primary user device to authenticate a secondary user device, according to the present disclosure.

### DETAILED DESCRIPTION

Examples of the present disclosure generally include systems and methods for authenticating an untrusted device to have access to a secure account and, more particularly, include systems and methods for selectively authenticating a device based on a trust level calculated by an association between the untrusted device and a trusted device.

The systems and methods described herein are necessarily rooted in computer technology as they relate to digital accounts and the ability to selectively calculate a degree of access to the account that is provided to a secondary device (i.e., previously-untrusted device). The processing requirements to authenticate the secondary device can be shared between the authentication system (backend), the primary user device, and the secondary user device. For example, prior designs required the backend system to populate a login page for display in a graphical user interface (GUI), receive login credentials, request whether the secondary device should be authenticated as a trusted device, and authenticate the secondary device for subsequent use. The present disclosure, however, allows the primary device to initiate an authentication request, allows the backend to confirm the request and transfer an authorization token, and allows the secondary device to register using the token. Additionally, the security of the digital accounts is improved by limiting the access to a digital account based on the relationship between the primary and secondary device, as will be described below.

Throughout this disclosure, it can be understood that an untrusted device is a device that has not previously been registered, or authenticated, to access an account page. A primary device can be understood to mean a device that has already been registered by a user of the account such that the device can be used to access the account. The term “primary” does not mean that the user or device is associated with a main or original account holder device, though it can mean that a primary user is the original, authorized account holder. A secondary device can be an untrusted device that the user wishes to register/authenticate to access the account. A secondary device can, therefore, become a primary, or trusted, device once the processes described herein authenticate the device to access the account. The “accounts” described herein can include personal and/or sensitive information, such that the authorization of devices increases the security of the information stored within said account. The accounts can include a financial account that allows authorized users to view and alter financial data stored within said account. However, it should be noted that any type of digital account can be utilized in accordance with the systems and methods described herein.

The present disclosure relates generally to systems and methods for authenticating an untrusted device to have access to a secure account and, more particularly, to systems and methods for selectively authenticating a device based on a trust level. The trust level can be calculated based an association between the untrusted device and a trusted device. Prior systems for authenticating a new device, either a new device for the primary user or a new device associated with a different user, required the registered user to access the webpage or application associated with the account on the new device, enter personal identification information (e.g., username and password), select to register the device as a trusted device, and proceed to the account page. As can be seen, this is a labor intensive process that requires the new device and backend system to trade sensitive information to register the new device.

The present systems, however, provide a frictionless process for authenticating an untrusted device. For example, when a customer purchases a new phone, they can access an account (e.g., a financial account) on the old device and seek authorization of the new device. In this manner, the user does not need to go through the process of logging in on the new device, selecting to register the new device, etc. This process can also be particularly helpful for authorizing a batch of devices. A financial institution branch can use the process to authenticate several devices at once for its sales representatives, cellular phone carrier stores can authenticate multiple tablets at once so as to conduct their internal business, etc.

Reference will now be made in detail to exemplary examples of the disclosed technology, examples of which are illustrated in the accompanying drawings and disclosed herein. Wherever convenient, the same reference numbers will be used throughout the drawings to refer to the same or like parts.

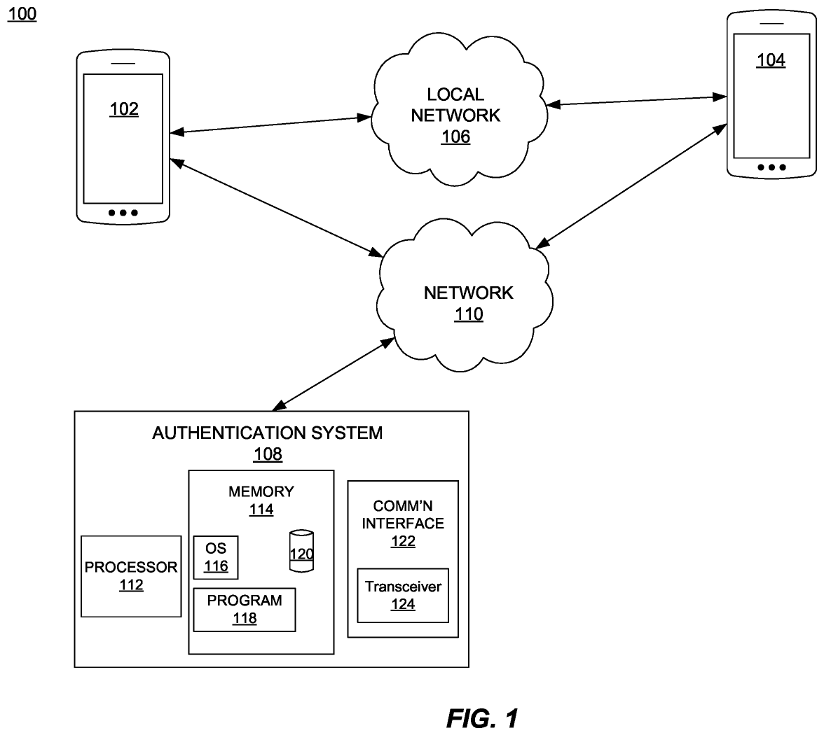

FIG. 1 is a diagram of an example system 100 that can be used to implement one or more examples of the present disclosure. A more detailed explanation of the components of the system 100 is provided below. It is beneficial, however, to provide a brief overview to describe the components of the systems and methods for authenticating untrusted devices described herein. The system can include a first device 102. The first device 102 can be referred to herein as the primary device, which is the device that has already been registered to access a user account (e.g., a trusted device). The system can include a second device 104. The second device 104 can be referred to herein as the secondary device, which is the device that has not previously been registered to access a user account (e.g., an untrusted device). The first device 102 and second device 104 can communicate with each other over a local network 106. The local network 106 can be a short-range wireless network, for example, radio-frequency identification (RFID), near-field communication (NFC), Bluetooth™, low-energy Bluetooth™ (BLE), Apple AirDrop™, and the like. As will be described in greater detail below, the use of a short-range wireless local network 106 to connect the first device 102 to the second device 104 can facilitate the authentication of the second device 104, for example by using a successful connection as a means to calculate a trust level for authenticating the second device 104.

The system 100 can include an authentication system 108. The authentication system 108 can be affiliated with the account in which the second device 104 is being authenticated to access. For example, the authentication system 108 can be a backend system for a financial institution, an internet service provider, an electronic mail system, or any other type of digital account. The authentication system 108 can receive the authentication requests to authenticate the second device 104, transmit authentication tokens to authenticate the second device 104, calculate the trust levels described herein, and the like.

The authentication system 108, first device 102, and second device 104 can communicate via a wired or wireless network 110. The network 110 can, therefore, facilitate the authentication of the second device 104, as described herein. The wired networks can be an Ethernet network and the wireless networks can be cellular or WiFi™ networks, for example. In some examples, network 110 can connect terminals, services, and user devices using direct connections such as RFID, NFC, Bluetooth™, low-energy Bluetooth™ (BLE), WiFi™, ZigBee™, ambient backscatter communications (ABC) protocols, USB, WAN, or LAN. Because the information transmitted can be personal or confidential (e.g., it can include passwords or other identifying information), the connections can also be encrypted or otherwise secured. It is contemplated that the first device 102 and second device 104 can communicate with each other over one type of network (e.g., Bluetooth™, etc.), and the authentication system 108, first device 102, and second device 104 can communicate over a different type of network (e.g., cellular network, WiFi™ network, etc.).

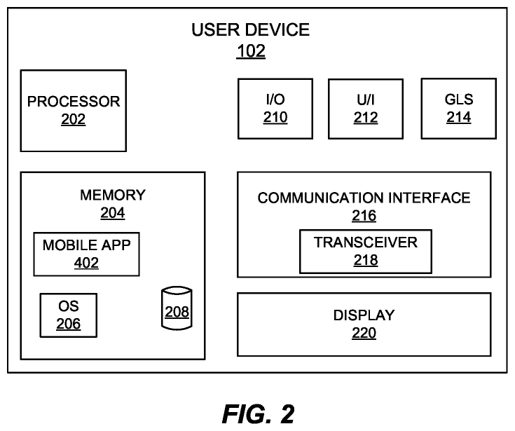

FIG. 2 is a component diagram of an example first device 102, according to the present disclosure. Although only the first device 102 is shown in FIG. 2, the second device 104 can be substantially similar to the first device 102. The first device 102 can be a mobile computing device (e.g., a smart phone, tablet computer, smart wearable (e.g., a smart watch), portable laptop computer, voice command device, wearable augmented reality device, or other mobile computing device) or a stationary device (e.g., desktop computer). The first device 102 can include a processor 202 and a memory 204, operating system (“OS”) 206, one or more programs (e.g., application 602 described below), and/or data storage 208. The first device 102 can also include a communication interface 216 that includes a transceiver 218. The communication interface 216 and/or transceiver 218 can be used to transmit and/or receive the data described throughout this disclosure, including for example the short-range wireless connections, the digital token, etc.

The first device 102 can also include one or more input/output (“I/O”) devices 210 that can include one or more interfaces for receiving signals or input from devices and providing signals or output to one or more devices that allow data to be received and/or transmitted by the first device 102. For example, the first device 102 can include interface components, which can provide interfaces to one or more input devices, such as one or more keyboards, mouse devices, touch screens, track pads, trackballs, scroll wheels, digital cameras, microphones, sensors, and the like, that allow the first device 102 to receive data from one or more users.

The first device 102 can also include a user interface (“U/I”) device 212 for receiving user input data, such as data representative of a click, a scroll, a tap, a press, or typing on an input device that can detect tactile inputs. According to some examples, U/I device 212 can include some or all of the components described with respect to I/O device 210 above. The U/I device 212 can be defined as the “input” of the first device 102. The first device 102 can also include a geographic location sensor (“GLS”) 214 for determining the geographic location of the first device 102.

The first device 102 can include a display 220. The display 220 can provide visual representation of the applications (e.g., application 602) and/or GUIs associated with those applications and GUIs described herein. The display 220 can also be a U/I device 212 in the case that the first device 102 has touchscreen capabilities. In other words, in some examples the display 220 can be the “input” of the first device 102.

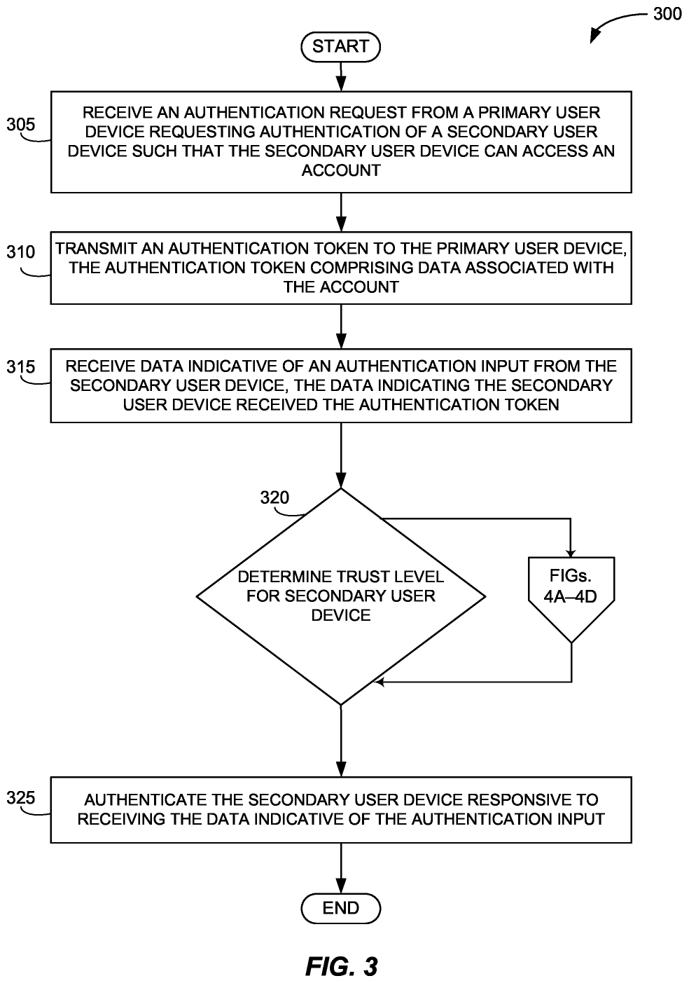

FIG. 3 is a flowchart of an example process 300 for authenticating an untrusted device, according to the present disclosure. Process 300 can be performed in whole or in part by the components of the authentication system 108, for example a processor 112, memory 114, and instructions (e.g., OS 116 and program 118) described below. Process 300 can begin at block 305, which includes receiving an authentication request from a primary user device (e.g., first device 102) requesting authentication of a secondary user device (e.g., second device 104) such that the secondary user device can access an account. As stated above, the account can be an online account that, for example, maintains sensitive data for a user that accesses the account via the primary, trusted user device. The authentication request sent to the authentication system 108 can be generated in a number of ways. For example, the authentication system 108 can receive the authentication request automatically and responsive to the primary user device and the secondary user device completing a short-range wireless connection to each other. Using a Bluetooth™ handshake as an example, either the primary device or the secondary device can be set into pairing mode so that the other of the two devices can discover the paring device. The pairing can be completed in an application associated with the account (e.g., application 602) such that, once paired, the authentication system 108 receives a notification of the paired devices. At this point, the authentication token can be transmitted to the primary user device either automatically or, alternatively, after a user of the primary user device selects an option to receive an authentication token for the secondary user device. Alternatively or in addition, the primary user device or the secondary user device can transmit the authentication request to the authentication system manually. For example, the primary user device can select an option in an application associated with the account (e.g., application 602) that requests a new authentication token to authorize a new device.

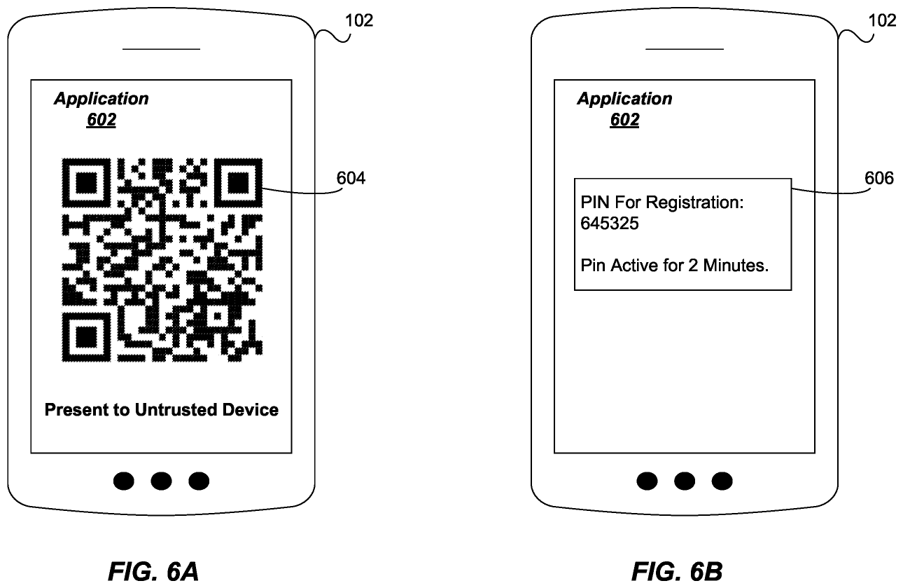

At block 310, process 300 can include transmitting an authentication token to the primary user device. The authentication token can include data associated with the account. For example, the authentication token can include account information or portions of account information (e.g., a financial account number) associated with the account. As will be described in greater detail below, the authentication token can take several forms, all of which can increase the security of the information being transmitted to the devices. For example, the account information or portions of account information can be encrypted or hashed prior to transmitting to the primary user device. The authentication token can be a packet of data, such as a digital certificate, that can be transmitted to the devices to authenticate one or more devices. In other examples, the authentication token can be an authorization code, for example a string of characters including letters, numbers, and/or special characters, that can be used to authenticate a device. The authorization code can be active for a predetermined period of time, for example, 1 minute, 5 minutes, an hour, etc., to further increase the security of the system by limiting the amount of time a potential fraudster can access the authentication code. If the secondary user device does not input the authentication code (e.g., into a GUI as shown for the application 602 in FIGS. 6A and 6B) within that predetermined period of time, the authentication system 108 can deactivate the code, and a new authentication request (i.e., at block 305) may be required. In other examples, the authentication token can include an image, such as a Quick Response (QR) code, barcode, data matrix, etc., that can be scanned by the secondary user device. Examples of authentication tokens are described in greater detail below with reference to FIGS. 6A and 6B.

At block 315, process 300 can include receiving data indicative of an authentication input from the secondary user device. This data can indicate to the authentication system 108 that the secondary user device received the authentication token. For example, if the secondary user device is operating an application (e.g., application 602) associated with the authentication system 108, the authentication system 108 can receive an indication that the secondary user device received and/or inputted the token (e.g., code, certificate, scanned image, etc.).

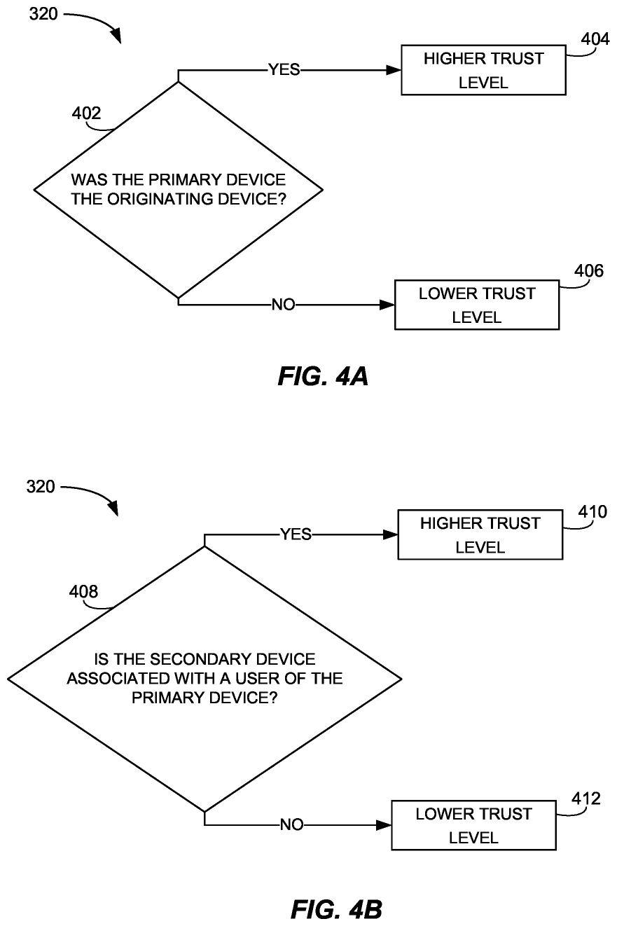

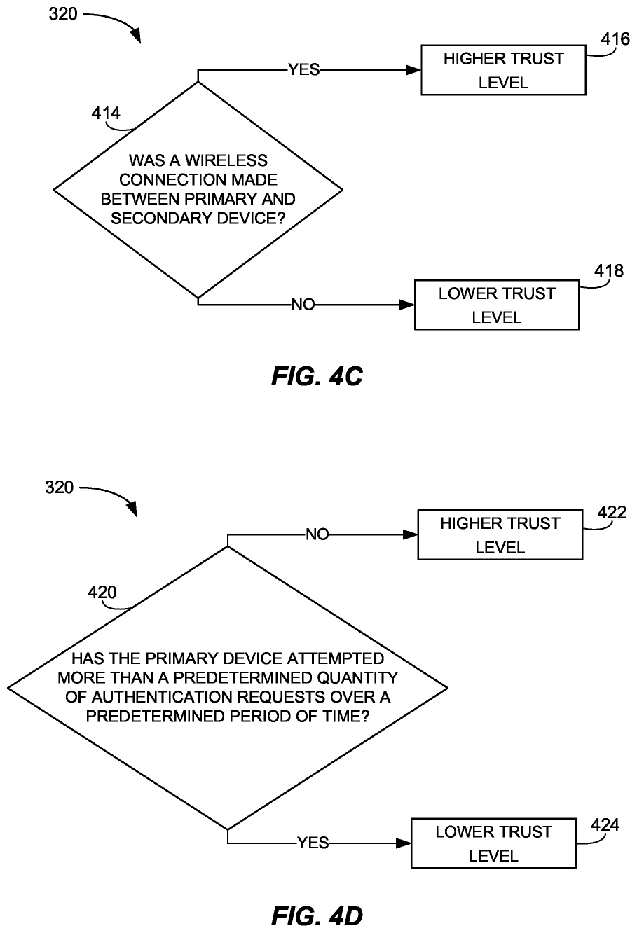

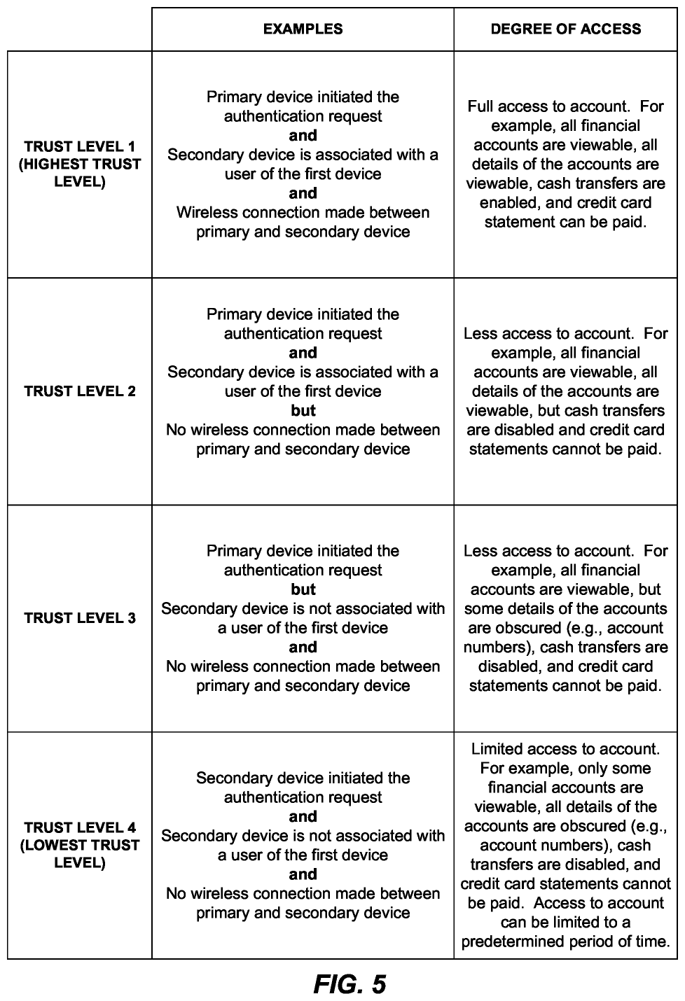

At block 320, process 300 can include determining a trust level for the secondary user device. The trust level can be used to determine a degree of access and/or duration of access to the account provided to the secondary user device. Example factors that can be used for determining a trust level are described in greater detail with reference to FIGS. 4A-5. Summarily, the trust level can be determined based on a relationship between the primary user device and the secondary user device (e.g., if the secondary user device is associated with the primary user, if the primary user device wirelessly connected to the secondary user device, if the primary user device or the secondary user device initiated the authentication request, etc.). The authentication system 108 can determine the trust level after receiving the data indicative of the authentication input from the secondary user device, as shown in FIG. 3 and in blocks 315 and 320. Alternatively, the authentication system 108 can determine the trust level prior to transmitting the authentication token (i.e., prior to block 310), and the authentication token can include data associated with the trust level.

At block 325, process 300 can include authenticating the secondary user device responsive to receiving the data indicative of the authentication input. The authentication of the secondary user device can provide the secondary user device access to the account. Further, a degree of access to the account can be based upon the trust level calculated in block 320. Process 300 can end after block 325. In other examples, additional steps can be performed according to the examples described herein or other examples.

FIGS. 4A-4D depict factors that can be used in determining a trust level, according to the present disclosure. As indicated in each of FIGS. 4A-4D, these factors can form all or part of the determination step described in block 320 of FIG. 3. Referring to FIG. 4A, the factor includes determining 402 whether the primary device was the originating device. The originating device can be the device that initially transmits the authentication request to the authentication system 108. For example, a primary user device (e.g., first device 102) can request that another device (e.g., second device 104) be authenticated, for example by submitting the request manually (e.g., a user selects an option to request authentication, for example in application 602) or automatically (e.g., upon a successful pairing of the primary user device and the secondary user device). Similarly, the second device 104 can be the originating device by sending the authentication request to the authentication system 108, either automatically (e.g., based on a connection between the devices) or manually (e.g., based on a request inputted into the second device 104). If the originating device is the second device 104, this authentication request can be deemed less secure than if the first device 102 originated the authentication request. In other words, there is more of a chance that a potential fraudster is trying to authenticate a new device for the secure account if a secondary device requests authentication than if the primary device requested authentication. To this end, if the first device 102 is the originating device, the secondary device can have a higher trust level at block 404; if the second device 104 is the originating device, the secondary device can have a lower trust level at block 406. Having a higher trust level (e.g., at block 404) can be defined as the authentication system 108 increasing the trust level; having a lower trust level (e.g., at block 406) can be defined as the authentication system 108 decreasing the trust level.

Referring to FIG. 4B, the factor includes determining 408 whether the second device 104 is associated with a user of the first device 102. For example, this factor can be used to determine if the user is setting up a new device for him/herself or if the user is setting up an authenticated device for another user (e.g., a child, a spouse, a co-worker, etc.). To determine whether the second device 104 is associated with a primary user (or primary user device), the process can include additional authorization steps. For example, the first device 102 can receive a prompt from the authentication system 108 (e.g., within application 602) asking if the user is setting up a new device. Furthermore, additional user authorization can be required. For example, if the user is setting up his/her own user device, a notification can be sent to the first device 102 seeking a password, personal identification number (PIN), or other authenticating information. A notification can be transmitted (e.g., from the authentication system 108) to the first device 102 via push notification, email, short-message-service (SMS), or the like seeking the additional authenticating information. Alternatively or in addition, the first device 102 can be unauthenticated (or untrusted) in response to authenticating a new, second device 104. If the second device 104 is associated with a user of the first device 102, the secondary device can have a higher trust level at block 410; if the second device 104 is associated with a user other than the user of the first device 102, the secondary device can have a lower trust level at block 412.

Referring to FIG. 4C, the factor includes determining 414 whether a wireless connection was made between the primary and secondary devices. A wireless connection between the first device 102 and second device 104 can be used as a security authorization step for authenticating the second device 104. For example, Bluetooth™ pairing requires the devices to accept the handshake, so that not all connection attempts from one device to the other are successful. Similar is true for Apple AirDrop™ technology, where the device receiving the request must receive an indication of accepting the connection before the connection is made between the devices. Further, using a short-range wireless communication, such as RFID, NFC, Bluetooth™, low-energy Bluetooth™ (BLE), Apple AirDrop™, and the like can ensure the first device 102 and second device 104 are in close proximity With this proximity protection, the first device 102 is protected from potential fraudsters that scan a longer range network (e.g., WiFi™, cellular, etc.) attempting to find a device in which to connect to receive an authentication token. If the first device 102 and second device 104 successfully connect via a wireless network, the secondary device can have a higher trust level at block 416; if the first device 102 and second device 104 do not connect via a wireless network, the secondary device can have a lower trust level at block 418.

Referring to FIG. 4D, the factor includes determining 420 whether the primary device has attempted more than a predetermined quantity of authentication requests over a predetermined period of time. This factor can prevent a fraudster from using the first device 102 to authenticate countless additional user devices. For example, the user of the first device 102 can manually input a total number of device authentications that it wishes to perform over a period of time, for example a month, a year, etc. If the number of authentication requests (see, e.g., block 305 in FIG. 3) exceeds that quantity of device authentications over that time period, the authentication system 108 can deny any subsequent authentication requests (i.e., the system does not send an authentication token). This predetermined maximum device authentication threshold can also be set by the authentication system 108. To illustrate, the authentication system 108 can set for all customers a maximum of two authentication requests over the course of a twelve-month period. If the first device 102 attempts a subsequent authentication request beyond those two authentication requests, the authentication system 108 can deny any subsequent authentication requests. If the first device 102 has requested more than a predetermined quantity of authentication requests over a predetermined period of time, the secondary device can have a lower trust level at block 422; if the first device 102 has requested fewer than the predetermined quantity of authentication requests over the predetermined period of time, the secondary device can have a higher trust level at block 422.

The factors in FIGS. 4A-4D are merely illustrative and are not exhaustive, and other factors can be used to determine a trust level. For example, a factor can include determining whether the second device 104 (or user thereof) has an account associated with the authentication system 108. These additional factors are contemplated herein for determining a trust level.

FIG. 5 is an example algorithm for determining a trust level and allocating a degree of access to an account based on the trust level, according to the present disclosure. Any of the factors described in FIGS. 4A-4D can be used alone to determine a trust level for the secondary user device (e.g., second device 104), or multiple factors can be used to provide a sliding scale of trust levels, as illustrated in FIG. 5. For example, a Trust Level 1 (as determined by the authentication system 108) can be set for scenarios when (a) the first device 102 initiated the authentication request (FIG. 4A), and (b) the second device 104 is associated with a user of the first device 102 (FIG. 4B), and (c) a wireless connection was made between the first device 102 and second device 104 (FIG. 4C). Trust Level 1 can be the highest trust level and, therefore, the second device 104 can have the highest degree of access to the account, i.e., as if the primary user owned the second device 104. This degree of access can be defined, for example, as all financial accounts being viewable by the second device 104, all details of the accounts being viewable (e.g., account numbers, account balances, etc.) by the second device 104, cash transfers being allowed for the second device 104, and credit card payments being allowed for the second device 104.

A lower trust level can be assigned to the second device 104 if any of the factors indicate the trust level should be lower. For example, a Trust Level 2 can be set for the second device 104 if (a) the first device 102 initiated the authentication request, and (b) the second device 104 is associated with a user of the first device 102, but (c) a wireless connection was not made between the first device 102 and second device 104. For this trust level, the second device 104 can have a lower degree of access to the account. This lower degree of access can be defined, for example, as all financial accounts being viewable by the second device 104, all details of the accounts being viewable (e.g., account numbers, account balances, etc.) by the second device 104, but cash transfers and credit card payments being disabled for the second device 104.

As can be seen in FIG. 5, this progression of lesser degree of access resulting from a lower trust level can continue until the factors indicate the second device 104 should receive a lowest trust level, shown as Trust Level 4 in FIG. 5. For example, a Trust Level 4 can be set for the second device 104 if (a) the second device 104 initiated the authentication request, and (b) the second device 104 is associated with a user other than the user of the first device 102, and (c) a wireless connection was not made between the first device 102 and second device 104. This lowest degree of access can be defined, for example, as providing the second device 104 access to only a portion of the financial accounts associated with the account, obscuring all account details from view by second device 104, and disabling cash transfers and credit card payments by the second device 104. Additionally, the second device 104 can have a limited duration of access to the account. For example, the second device 104 can have the limited degree of access for a day, a week, etc. and, once the predetermined duration of access has lapsed, the second device 104 can be unauthenticated (i.e., untrusted). Alternatively or in addition, the primary user device (e.g., first device 102) can receive a notification asking if the second device 104 should receive permanent access to the account. The example trust levels and the algorithm to assign trusts levels are merely illustrative and are in no way limiting on how the trust levels or degrees of access can be assigned by the authentication system 108. Further, the factors used in FIG. 5 can be moved into different trust level categories and or weighted according to importance. For example, which device initiated the authentication request can be weighted more heavily than if a wireless connection was made, more heavily than if the secondary device is associated with a user of the first account, etc.

FIGS. 6A and 6B depict example interfaces for transmitting authentication tokens capable of authenticating a second device 104, according to the present disclosure. Referring to FIG. 6A, the authentication tokens described above can be in the form of an image 604 displayable on the primary user device (e.g., first device 102) and scannable by the secondary user device (e.g., second device 104). The image 604 can include, for example, a QR code, barcode, data matrix, etc., that can be scanned by the secondary user device to authenticate the device. FIG. 6A shows an example QR code that can be used to authenticate the second device 104. The image 604 can include information related to the account, for example account numbers, account names, a password, etc. The image 604 can also include information about the trust level associated with the second device 104, as described above with reference to FIGS. 4A-5. Once the authentication system 108 receives the authentication request from the first device 102 or the second device 104, the authentication system can transmit the authentication token to the first device 102. The image 604 can be displayable in a GUI that can be populated by an application 602 provided by the authentication system 108. Once displayed on the first device 102, the user of the first device 102 can present the image 604 to the second device 104, and the second device 104 can scan the image with an I/O device 210 (e.g., a digital camera). The image 604 can be encrypted by the authentication system 108 prior to being encoded for transmitting to the first device 102. For example, the account information embedded into the image 604 can be encrypted or hashed, thereby further improving the security of the system.

FIG. 6B shows an alternative to an image, and includes an authorization token that is a single-use authentication code 606 that can be inputted into the second device 104 to authenticate the second device 104. The authentication code 606 can be a string of characters, including numbers, letters, and/or special characters, that can be inputted into an application 602 operating on the second device 104. The authentication code 606 can be active for a limited duration of time to prevent inadvertent transmission of the code outside of the window that the primary user wishes to activate the second device 104. For example, the authentication system 108 can allow the authentication code 606 to be used for device authentication for a period of seconds, minutes, etc., and if the code is not entered into a device for authentication within that period of time, the authentication process can be reinitiated.

As described above, other types of authentication tokens are also contemplated. For example, the authentication token can be a data packet, such as a digital certificate, that can be transmitted to the second device 104. The examples described herein include examples wherein the first device 102 and second device 104 are connected via a wireless (e.g., short-range wireless) connection. This connection can be maintained between the devices and, once the first device 102 receives the digital certificate from the authentication system 108, the first device 102 can transmit the digital certificate to the second device 104 for authentication. These and other authorization tokens are contemplated here.

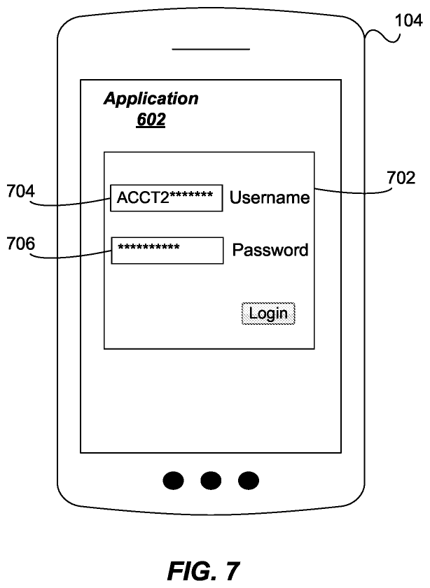

FIG. 7 is an example GUI for a second device 104 allowing the second device to maintain access to the account after the initial authentication, according to the present disclosure. The authentication system can generate a GUI with a login field 702 for login information, such as a username field 704 and a password field 706. The GUI can be displayed within the application 602 associated with the authentication system 108 and/or account. The example interface shown in FIG. 7 provides an option for the systems and processes described herein to allow the second device 104 to have access to the account beyond the initial initiation phase. For example, the processes described herein create a trusted device (the second device 104) such that the device can be used to access an account. After the initial authentication period is over, however, the second device 104 may need an additional process for allowing a user of the second device 104 to access the account in subsequent attempts. One option for this is to automatically generate account login information that can be used to access the account going forward. The authentication system 108 can generate the login information for the secondary user device (e.g., second device 104) and populate the login information into the login field 702. This can allow subsequent logins to the account using the secondary device. This information can be saved permanently into the login field 702 until a user of the second device 104 decides to change the login information to personalized information (e.g., a personal username and/or password).

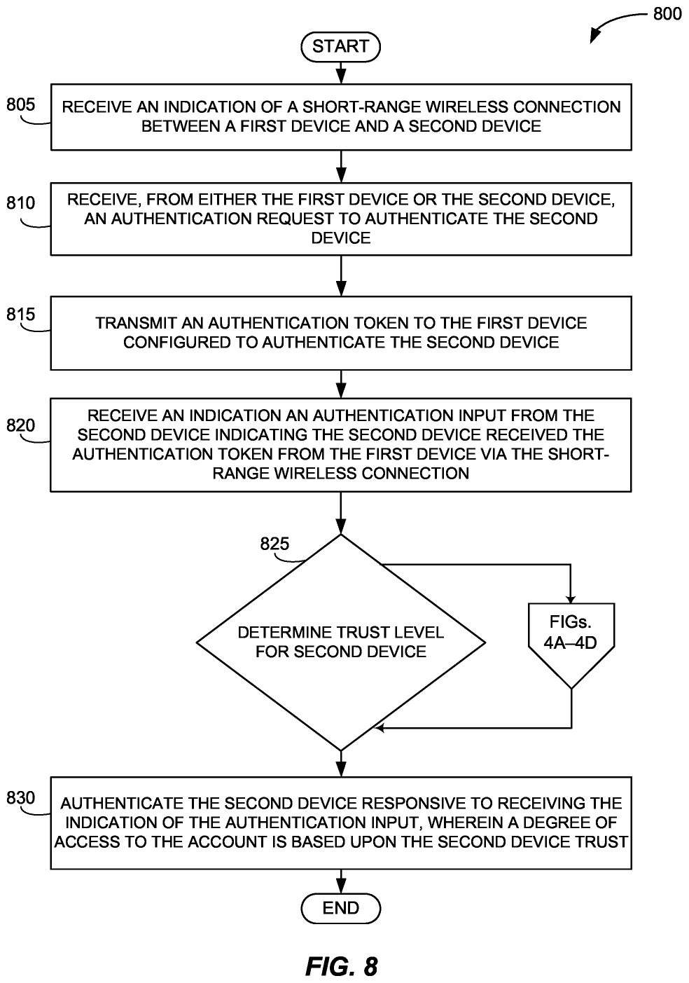

FIG. 8 is a flowchart of an example process 800 for authenticating a user device for accessing an account, according to the present disclosure. Process 800 can be performed in whole or in part by the components of the authentication system 108, for example a processor 112, memory 114, and instructions (e.g., OS 116 and program 118) described below. Process 800 can begin at block 805, which includes receiving an indication of a short-range wireless connection between a first device (e.g., first device 102) and a second device (e.g., second device 104). The first device can be the trusted device in the process and can be authenticated for viewing account information for a user account. The second device can be an untrusted device not initially authenticated to view the account information.

At block 810, process 800 can include receiving, from either the first device or the second device, an authentication request to authenticate the second device. At block 815, process 800 can include transmitting an authentication token to the first device, wherein the authentication token is operable to authenticate the second device to access the user account. At block 820, process 800 can include receiving an indication of an authentication input from the second device indicating the second device received the authentication token from the first device via the short-range wireless connection. The indication that the second device received the authentication input can be data transmitted to the authentication system 108 indicating receipt, and/or the indication can be a direct response to a user inputting the authentication token into the second device (e.g., by scanning an image 604, inputting an authentication code 606, etc.).

At block 825, process 800 can include determining a second device trust level. The determination step at block 825 can be similar to the process described above for block 320 in FIG. 3. At block 830, process 800 can include authenticating the second device responsive to receiving the indication of the authentication input. A degree of access to the account for the second device can be based upon the second device trust level, as described above with reference to FIGS. 4A—D and 5.

Process 800 can end after block 830. In other examples, additional steps can be performed according to the examples described herein or other examples. For example, the system can generate a GUI associated with the account, and the account information displayed in the GUI can be based upon the degree of access for the second device. Additionally, the process can be completed, either subsequently or concurrently, for a third device. In this example, the process can include (a) receiving an indication of a short-range wireless connection between the first device and the third device, the third device being an untrusted device not initially authenticated to view the account information, (b) receiving an indication of the authentication input from the third device indicating the third device received the authentication token from the first device via the short-range wireless connection, (c) determining a third device trust level, and (d) authenticating the third device responsive to receiving the indication of the authentication input. The degree of access to the account for the third device can be based upon the third device trust level. It is contemplated that the second device trust level and the third device trust levels are the same trust level. However, it can also be the case that the two trusts levels are different. Referring to FIG. 5 to illustrate, the second device trust level can be determined to fall into Trust Level 3, in that the first device and second device are associated with different users (i.e., the second device is not associated with a user of the first device). However, the third device may be associated with the user of the first device, so the third device is assigned Trust Level 2. This can be valuable for a family that purchases several new devices, and the main account holder's device is assigned a higher trust level than another member of the family, like a child or spouse of the main account holder.

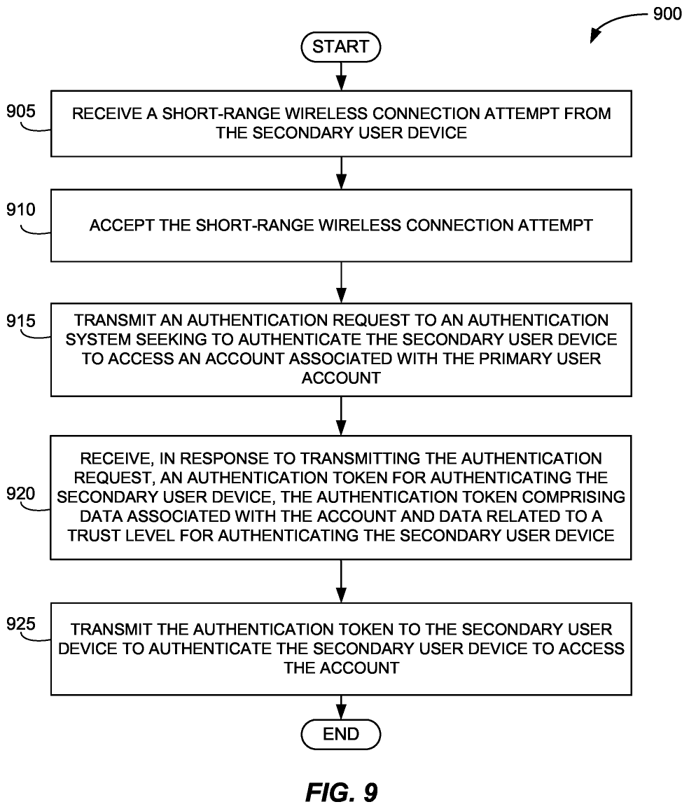

FIG. 9 is a flowchart of an example process 900 for a primary user device, allowing the primary user device to authenticate a secondary user device, according to the present disclosure. Process 900 can be performed in whole or in part by the components of the primary user device (e.g., first device 102), for example the transceiver 218, processor 202, and memory 204. Process 900 can begin at block 905, which includes receiving a short-range wireless connection attempt from the secondary user device (e.g., second device 104). At block 910, process 900 can include accepting the short-range wireless connection attempt. At block 915, process 900 can include transmitting an authentication request to an authentication system (e.g., authentication system 108) seeking to authenticate the secondary user device to access an account associated with the primary user account. At block 920, process 900 can include receiving, in response to transmitting the authentication request, an authentication token for authenticating the secondary user device. The authentication token can include data associated with the account and data related to a trust level for authenticating the secondary user device. At block 925, process 900 can include transmitting the authentication token to the secondary user device to authenticate the secondary user device to access the account. Process 900 can end after block 925. In other examples, additional steps can be performed according to the examples described herein or other examples.

Referring again to the system 100 described in FIG. 1, the authentication system 108 can include one or more processors 112, a memory 114, and data storage, for example in database 120. The processor 112 can include one or more of a microprocessor, microcontroller, digital signal processor, co-processor or the like or combinations thereof capable of executing stored instructions and operating upon stored data.

The memory 114 of the authentication system 108 can include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data.

The memory 114 of the authentication system 108 can contain an operating system (“OS”) 116 that can run one or more programs 118. The one or more programs 118 can perform one or more functions of the disclosed examples. The one or more programs 118 can include, for example, a program for creating the application 602 operable on the user devices (e.g., first device 102 and second device 104) and generating the GUIs described herein.

The memory 114 can also include any combination of one or more databases, including for example database 120, controlled by memory controller devices (e.g., server(s), etc.) or software, such as document management systems, Microsoft® SQL databases, SharePoint® databases, Oracle® databases, Sybase® databases, or other relational databases.

The authentication system 108 can include a communication interface 122 for communicating with external systems or internal systems. The communication interface 122 can include a serial port, a parallel port, a general-purpose input and output (GPIO) port, a game port, a universal serial bus (USB), a micro-USB port, a high definition multimedia (HDMI) port, a video port, an audio port, a Bluetooth™ port, an NFC port, another like communication interface, or any combination thereof. The communication interface 122 can include a transceiver 124 to communicate with compatible devices. A transceiver 124 can be compatible with one or more of: RFID, NFC, Bluetooth™, low-energy Bluetooth™ (BLE), WiFi™, ZigBee™, ambient backscatter communications (ABC) protocols, or similar technologies that allows the authentication system 108 to communicate via the network 110 described herein.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described in this disclosure as making up various elements of the systems and methods are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Examples of the present disclosure can be implemented according to at least the following clauses:

Clause 1: A system for authenticating an untrusted device, comprising: one or more processors; and memory in communication with the one or more processors and storing instructions that, when executed by the one or more processors, are configured to cause the system to: receive an authentication request from a primary user device requesting authentication of a secondary user device such that the secondary user device can access an account; transmit an authentication token to the primary user device, the authentication token comprising data associated with the account; receive data indicative of an authentication input from the secondary user device, the data indicating the secondary user device received the authentication token; determine a trust level for the secondary user device; and authenticate the secondary user device responsive to receiving the data indicative of the authentication input, the authentication providing the secondary user device access to the account, wherein a degree of access to the account is based upon the trust level.

Clause 2: The system of claim 1, wherein the instructions are further configured to cause the system to generate a graphical user interface (GUI) associated with the account, wherein data displayed in the GUI is based upon the degree of access for the secondary user device.

Clause 3: The system of claim 1, wherein: the authentication request comprises data indicative of the secondary user device being associated with a user of the primary user device; and in response to receiving the data indicative of the secondary user device being associated with the user, the instructions are configured to cause the system to increase the degree of access and increase the trust level of the secondary user device.

Clause 4: The system of claim 1, wherein: the authentication request comprises data indicative of the secondary user device being associated with a first user other than a second user of the primary user device; and in response to receiving the data indicative of the secondary user device being associated with the first user, the instructions are configured to cause the system to decrease the degree of access and decrease the trust level of the secondary user device.

Clause 5: The system of claim 4, wherein authentication of the secondary user device is for a limited duration of time based on the trust level.

Clause 6: The system of claim 1, wherein the authentication token is an image displayable on the primary user device and scannable by the secondary user device, the image comprising information related to the account.

Clause 7: The system of claim 6, wherein: the image is a Quick Response (“QR”) code comprising an encrypted account identifier for the account; and authentication of the secondary user device is responsive to decrypting the encrypted account identifier.

Clause 8: The system of claim 1, wherein: the authentication request comprises data indicative of a wireless connection between the primary user device and the secondary user device; and the authentication token is a file wirelessly transferrable from the primary user device to the secondary user device via the wireless connection.

Clause 9: The system of claim 8, wherein: the data indicative of the wireless connection comprises an indication of a request originating device; when the primary user device is the request originating device, the instructions are configured to cause the system to assign a first trust level to the secondary user device; when the secondary user device is the request originating device, the instructions are configured to cause the system to assign a second trust level to the secondary user device; and the first trust level is a higher trust level than the second trust level.

Clause 10: The system of claim 1, wherein the instructions are further configured to cause the system to: generate a GUI associated with the account with a login field for login information; generate the login information for the secondary user device; and populate the login information into the login field, thereby allowing subsequent logins to the account using the secondary user device.

Clause 11: A system for authenticating a user device for accessing an account, the system comprising: one or more processors; and memory in communication with the one or more processors and storing instructions that, when executed by the one or more processors, are configured to cause the system to: receive an indication of a short-range wireless connection between a first device and a second device, the first device being a trusted device authenticated for viewing account information for a user account, and the second device being an untrusted device not initially authenticated to view the account information; receive, from either the first device or the second device, an authentication request to authenticate the second device; transmit an authentication token to the first device configured to authenticate the second device; receive an indication of an authentication input from the second device indicating the second device received the authentication token from the first device via the short-range wireless connection; determine a second device trust level; and authenticate the second device responsive to receiving the indication of the authentication input, wherein a degree of access to the account is based upon the second device trust level.

Clause 12: The system of claim 11, wherein the instructions are further configured to cause the system to generate a graphical user interface (GUI) associated with the account, wherein data displayed in the GUI is based upon the degree of access for the second device.

Clause 13: The system of claim 11, wherein: the indication of a short-range wireless connection comprises an indication of a request originating device; when the first device is the request originating device, the instructions are configured to cause the system to assign a first trust level to the second device; when the second device is the request originating device, the instructions are configured to cause the system to assign a second trust level to the second device; and the first trust level is a higher trust level than the second trust level.

Clause 14: The system of claim 11, wherein the instructions are further configured to cause the system to: receive an indication of a short-range wireless connection between the first device and a third device, the third device being an untrusted device not initially authenticated to view the account information; receive an indication of the authentication input from the third device indicating the third device received the authentication token from the first device via the short-range wireless connection; determine a third device trust level; and authenticate the third device responsive to receiving the indication of the authentication input, wherein the degree of access to the account is based upon the third device trust level.

Clause 15: The system of claim 11, wherein: the authentication request comprises data indicative of the second device being associated with a user of the first device; and min response to receiving the data indicative of the second device being associated with the user, the instructions are configured to cause the system to increase the degree of access and increase the second device trust level.

Clause 16: The system of claim 11, wherein: the authentication request comprises data indicative of the second device being associated with a first user other than a second user of the first device; and in response to receiving the data indicative of the second device being associated with the first user, the instructions are configured to cause the system to decrease the degree of access and decrease the second device trust level.

Clause 17: The system of claim 16, wherein authentication of the second device is for a limited duration of time based on the second device trust level.

Clause 18: The system of claim 11, wherein the instructions are further configured to cause the system to: generate a GUI associated with the account with a login field for login information; generate the login information for the second device; and populate the login information into the login field, thereby allowing subsequent logins to the account using the second device.

Clause 19: A primary user device for authenticating a secondary user device, the device comprising: a transceiver; one or more processors; and memory in communication with the one or more processors and storing instructions that, when executed by the one or more processors, are configured to cause the primary user device to: receive, via the transceiver, a short-range wireless connection attempt from the secondary user device; accept the short-range wireless connection attempt; transmit an authentication request to an authentication system seeking to authenticate the secondary user device to access an account associated with the primary user account; receive, in response to transmitting the authentication request, an authentication token for authenticating the secondary user device, the authentication token comprising data associated with the account and data related to a trust level for authenticating the secondary user device; and transmit, via the transceiver, the authentication token to the secondary user device to authenticate the secondary user device to access the account.

Clause 20: The device of claim 19, wherein: when the primary user device initiates the short-range wireless connection attempt, the trust level is a first trust level; when the secondary user device initiates the short-range wireless connection attempt, the trust level is a second trust level; and the first trust level is a higher trust level than the second trust level.

### Exemplary Use Cases

The following exemplary use cases describe examples of a typical user flow pattern. They are intended solely for explanatory purposes and not limitation.

Jim purchases a new mobile phone and wishes to update all the applications in his phone to have access to his accounts. Ordinarily, this process would take a significant amount of time, since each application requires Jim to download the application, input his identification information, and select to trust his new device to access the account associated with the application. However, Jim has an account at National Bank that allows him to authenticate his new phone using his old device, thereby saving him time and effort at least for authenticating the new mobile phone with National Bank.

Jim opens the National Bank application on his old device and his new mobile phone. He then signs into his National Bank account on his old device, wirelessly pairs the old device and new mobile phone via the National Bank application, and receives a prompt on his old device asking if he wishes to authenticate a new device. He selects that he does and also selects that the device is owned by Jim. Jim's old device transmits an authentication request to the National Bank server and receives in return an authentication token from National Bank. Jim's old device transmits the authentication token, a digital certificate, to the new mobile phone, and the new mobile phone is fully authenticated. The new mobile phone can now log into the financial account as if Jim had gone through the process of logging in, selecting to trust the new mobile phone, etc. Further, since Jim connected the two devices wirelessly and selected that the new mobile phone was owned by Jim, National Bank assigned a highest trust level for the new mobile phone, providing a full degree of access to the financial account on the new mobile phone.

In the same initial fact patterns as above, Jim also wishes to allow his adult son to have access to his account. Jim accesses the National Bank application in his newly-trusted mobile phone and selects that he wishes to authenticate a new device. Jim receives another authentication token, this time in the form of a Quick Response (“QR”) code. Jim's son then scans the QR code on Jim's mobile phone and is authenticated to access Jim's account at National Bank. However, since no wireless connection was made between Jim and his son's devices, and since Jim did not indicate that this device was owned by him, National Bank assigned a medium trust level to the son's device, allowing him to view all financial accounts, but some details of the accounts are hidden and the son cannot move money from the accounts.

In the same initial fact patterns as above, Jim also wishes to authorize his co-worker to view some accounts Jim has at National Bank, i.e., corporate accounts but not his personal accounts. Jim's co-worker initiates an authentication request in his National Bank and inputs Jim's information into a GUI associated with the application. Jim then receives a notification on his new mobile phone asking if he approves the device authentication. Jim confirms and receives an authentication token in the form of a QR code. The co-worker scans the QR code and is authenticated for access to Jim's National Bank account. However, since no wireless connection was made and since the co-worker initiated the authentication request, National Bank sets a low trust level for the co-worker's device. Therefore, the co-worker's degree of access is limited; only some of the accounts are viewable in the co-worker's GUI and all account identifiers (i.e., account numbers) are hidden.

In another fact pattern, Alice is a manager at a local branch for a mobile carrier store. She receives a new shipment of computer tablets that can be used to access the mobile carrier's internal network for performing customer service. Instead of logging into each tablet individually, Alice takes advantage of the mobile carrier's new application that allows authenticating the devices using an already-authenticate device, her older tablet. Alice accesses the carrier's application and selects that she wishes to authenticate a device. She receives a barcode authentication token that is scannable by each of the new computer tablets. She scans the barcode displayed on the older tablet with each of the new tablets, and each new tablet is now authenticated to access the mobile carrier's internal network.

What is claimed is:

1. A system for authenticating an untrusted device, comprising:
one or more processors; and
memory in communication with the one or more processors and storing instructions that, when executed by the one or more processors, are configured to cause the system to:
receive an authentication request from a primary user device requesting authentication of a secondary user device such that the secondary user device can access an account;
transmit an authentication token to the primary user device, the authentication token comprising data associated with the account;
receive data indicative of an authentication input from the secondary user device, the data indicating the secondary user device received the authentication token;
determine a trust level for the secondary user device; and
authenticate the secondary user device responsive to receiving the data indicative of the authentication input, the authentication providing the secondary user device access to the account, wherein a degree of access to the account is based upon the trust level.

2. The system of claim 1, wherein the instructions are further configured to cause the system to generate a graphical user interface (GUI) associated with the account,
wherein data displayed in the GUI is based upon the degree of access for the secondary user device.

3. The system of claim 1, wherein:
the authentication request comprises data indicative of the secondary user device being associated with a user of the primary user device; and
in response to receiving the data indicative of the secondary user device being associated with the user, the instructions are configured to cause the system to increase the degree of access and increase the trust level of the secondary user device.

4. The system of claim 1, wherein:
the authentication request comprises data indicative of the secondary user device being associated with a first user other than a second user of the primary user device; and
in response to receiving the data indicative of the secondary user device being associated with the first user, the instructions are configured to cause the system to decrease the degree of access and decrease the trust level of the secondary user device.

5. The system of claim 4, wherein authentication of the secondary user device is for a limited duration of time based on the trust level.

6. The system of claim 1, wherein the authentication token is an image displayable on the primary user device and scannable by the secondary user device, the image comprising information related to the account.

7. The system of claim 6, wherein:
the image is a Quick Response (“QR”) code comprising an encrypted account identifier for the account; and
authentication of the secondary user device is responsive to decrypting the encrypted account identifier.

8. The system of claim 1, wherein:
the authentication request comprises data indicative of a wireless connection between the primary user device and the secondary user device; and
the authentication token is a file wirelessly transferrable from the primary user device to the secondary user device via the wireless connection.

9. The system of claim 8, wherein:
the data indicative of the wireless connection comprises an indication of a request originating device;
when the primary user device is the request originating device, the instructions are configured to cause the system to assign a first trust level to the secondary user device;
when the secondary user device is the request originating device, the instructions are configured to cause the system to assign a second trust level to the secondary user device; and
the first trust level is a higher trust level than the second trust level.

10. The system of claim 1, wherein the instructions are further configured to cause the system to:
generate a GUI associated with the account with a login field for login information;
generate the login information for the secondary user device; and
populate the login information into the login field, thereby allowing subsequent logins to the account using the secondary user device.

11. A system for authenticating a user device for accessing an account, the system comprising:
one or more processors; and
memory in communication with the one or more processors and storing instructions that, when executed by the one or more processors, are configured to cause the system to:
receive an indication of a short-range wireless connection between a first device and a second device, the first device being a trusted device authenticated for viewing account information for a user account, and the second device being an untrusted device not initially authenticated to view the account information;
receive, from either the first device or the second device, an authentication request to authenticate the second device;
transmit an authentication token to the first device configured to authenticate the second device;
receive an indication of an authentication input from the second device indicating the second device received the authentication token from the first device via the short-range wireless connection;
determine a second device trust level; and
authenticate the second device responsive to receiving the indication of the authentication input, wherein a degree of access to the account is based upon the second device trust level.

12. The system of claim 11, wherein the instructions are further configured to cause the system to generate a graphical user interface (GUI) associated with the account,
wherein data displayed in the GUI is based upon the degree of access for the second device.

13. The system of claim 11, wherein:
the indication of a short-range wireless connection comprises an indication of a request originating device;
when the first device is the request originating device, the instructions are configured to cause the system to assign a first trust level to the second device;
when the second device is the request originating device, the instructions are configured to cause the system to assign a second trust level to the second device; and
the first trust level is a higher trust level than the second trust level.

14. The system of claim 11, wherein the instructions are further configured to cause the system to:
receive an indication of a short-range wireless connection between the first device and a third device, the third device being an untrusted device not initially authenticated to view the account information;
receive an indication of the authentication input from the third device indicating the third device received the authentication token from the first device via the short-range wireless connection;
determine a third device trust level; and
authenticate the third device responsive to receiving the indication of the authentication input, wherein the degree of access to the account is based upon the third device trust level.

15. The system of claim 11, wherein:
the authentication request comprises data indicative of the second device being associated with a user of the first device; and
in response to receiving the data indicative of the second device being associated with the user, the instructions are configured to cause the system to increase the degree of access and increase the second device trust level.

16. The system of claim 11, wherein:
the authentication request comprises data indicative of the second device being associated with a first user other than a second user of the first device; and
in response to receiving the data indicative of the second device being associated with the first user, the instructions are configured to cause the system to decrease the degree of access and decrease the second device trust level.

17. The system of claim 16, wherein authentication of the second device is for a limited duration of time based on the second device trust level.

18. The system of claim 11, wherein the instructions are further configured to cause the system to:
generate a GUI associated with the account with a login field for login information;
generate the login information for the second device; and
populate the login information into the login field, thereby allowing subsequent logins to the account using the second device.

19. A primary user device for authenticating a secondary user device, the device comprising:
a transceiver;
one or more processors; and
memory in communication with the one or more processors and storing instructions that, when executed by the one or more processors, are configured to cause the primary user device to:
receive, via the transceiver, a short-range wireless connection attempt from the secondary user device;
accept the short-range wireless connection attempt;
transmit an authentication request to an authentication system seeking to authenticate the secondary user device to access an account associated with the primary user account;
receive, in response to transmitting the authentication request, an authentication token for authenticating the secondary user device, the authentication token comprising data associated with the account and data related to a trust level for authenticating the secondary user device; and
transmit, via the transceiver, the authentication token to the secondary user device to authenticate the secondary user device to access the account.

20. The device of claim 19, wherein:
when the primary user device initiates the short-range wireless connection attempt, the trust level is a first trust level;
when the secondary user device initiates the short-range wireless connection attempt, the trust level is a second trust level; and
the first trust level is a higher trust level than the second trust level.
